(19) United States
(12) Patent Application Publication
(10) Pub. No.: US 2025/0344652 A1
(43) Pub. Date: Nov. 13, 2025

(54) A SYSTEM FOR RETAINING WATER AND PROVIDING NUTRIENTS TO PLANTLETS

(71) Applicant: GLOBAL TREEGRO INC., Calgary (CA)

(72) Inventors: Jeremy Jordon WONG, Calgary (CA); Charmaine Natividad MAGALLANES, Calgary (CA)

(21) Appl. No.: 18/875,686

(22) PCT Filed: Jun. 16, 2023
(86) PCT No.: PCT/CA2023/050844

§ 371 Date: Dec. 16, 2024

Related U.S. Application Data
(60) Provisional application No. 63/353,417, filed on Jun. 17, 2022.

(51) Int. Cl. A01G 24/15; A01C 1/02; A01G 24/25; A01G 24/28; C05G 3/70

(52) U.S. Cl. CPC A01G 24/15; A01C 1/02; A01G 24/25; A01G 24/28; C05G 3/70

(57) ABSTRACT

The present application relates to a system for retaining water and providing nutrients to plantlets, comprising: (a) a first surface that is concaved, an opening, and an exterior wall extending between the first surface and the opening; (b) an interior cavity defined by an interior surface of the exterior wall, a second surface, and an opening that is opposite the second surface; and (c) a channel extending through the first surface and the second surface, the channel comprising a first end and a second end, the channel in fluid communication with the interior cavity, the first end being distal to the interior cavity and the second end being proximal to the interior cavity. The system can be constructed of a first organic material, a binding material and a buffering material. In some instances, the system further comprises one or more modules spatially disposed within the interior cavity.

### TECHNICAL FIELD

The present disclosure relates to a system for retaining water and providing nutrients to plantlets.

### BACKGROUND

Many hectares of agricultural crops and forests are lost every year around the world due to phenomena such as drought, deforestation, insect infestation, and forest fires. Evolving farming and re-forestation practices demand that such problems are not merely solved by innovation for the sake of innovation, but rather purposeful innovation with a focus and emphasis on environmental friendliness and sustainability.

It has been suggested that significant difficulties and high losses of potential crops arise in establishing the germination and growth of a plant in the first instance. It has also been shown that plants in general, once established in a suitable environment, are for the most part self-sufficient and may be cultivated. As a result, research has been directed towards discovering ways of improving the likelihood that plant seeds can become established as plantlets.

Forest regeneration depends, to a large extent, on seedling emergence and establishment, both of which are influenced by environmental and climatic variables. Large nurseries have been established to produce seedlings to be used in reforestation applications. To produce large number of forest seedlings needed for reforestation, sufficient time (generally one year minimum) and a labour and resource intensive process are required to grow the seedlings before such seedlings can be transplanted to a target site. In addition, after transplanting, some seedlings may experience transplanting shock, such as physiological stresses, owing to a change in environment. Transplant shock may result in negative effects on the seedlings' establishment, growth, and survival.

In an effort to move away from labour intensive practices associated with nurseries, various research groups have presented innovations that improve the likelihood that plant seeds can become established as plantlets. For example, U.S. Pat. No. 4,249,343 to Dannelly discloses various compositions of water-insoluble but water-sensitive polymeric microgels that may be used as a seed coating for providing protection for seeds. However, the polymer disclosed therein does not dissolve when contacted with water. In another example, Canadian Patent Number 2,000,620 discloses a plantable water-imbibing seed-containing tablet that forms into a gel capsule when contacted with sufficient moisture, the gel capsule enveloping a seed therein and providing said seed with nutrients required for developing into a plantlet. More recently, Canadian Patent Number 3,127,123 discloses a plantable water-imbibing seed-containing “module” (as such term is construed in this present application) that forms into a gel capsule when contacted with sufficient moisture, the gel capsule enveloping a seed therein and providing said seed with nutrients, including nutrients from worm castings, required for developing into a plantlet.

Prior art studies have shown that soil microbials and fungi can have direct effects on seedling growth and functional traits (Friesen, M. L. et al., 2011. Microbially mediated plant functional traits. Ann. Rev. Ecol. Evol. Syst. 42, 23-46). For example, it has been suggested that the addition of mycorrhizal fungi increases the root's absorptive area and thus increases the root's access to water and nutrients (Chen M. et al., 2018. Beneficial services of arbuscular mycorrhizal fungi—from ecology to application. Front Plant Sci 9:1270). It has also been suggested that an increase in root surface area conferred by mycorrhiza can assist seedlings increase above-ground biomass better than seedlings without mycorrhiza, thereby ensuring better survival and outplanting performance (Kannenberg, S. A., Phillips, R. P., 2016. Soil microbial communities buffer physiological responses to drought stress in three hardwood species. Oecologia 183, 631-641).

Prior art studies have also shown that gibberellins can assist in enhancing conifer seed germination (Henig-Sever N et al., 2000. Regulation of the germination of Aleppo pine (Pinus halepensis) by nitrate, ammonium, and gibberellin, and its role in post-fire forest regeneration. Physiologia Plantarum 108: 390-397). Prior art studies have shown that the combination of water absorbent polymers and organic matter may improve soil water retention and performance of seedlings grown in reclaimed areas (Miller V. S. et al., 2019. Hydrogel and Organic Amendments to Increase Water Retention in Anthroposols for Land Reclamation. Applied and Environmental Soil Science vol. 2019, Article ID 4768091).

Hydrogels have been discussed in the prior art as a possible way of providing moisture to seedlings over extended periods of time. However, hydrogels become ineffective if they dry out. For example, in heat conditions, surrounding enclosures (e.g. capsules) comprising hydrogels may desiccate and form hard, solid masses. Such desiccated masses would prevent seedling roots and shoots from emerging from an enclosure if such enclosure were not sufficiently moist. After reaching such level of dryness, more water than what may be required to moisten the surrounding enclosure may be required to re-hydrate the hydrogel to a useable state. Therefore, hydrogels may be ineffective in heat conditions given that the surrounding enclosure may become water saturated even before the hydrogel therein is re-hydrated. In addition, as hydrogels imbibe water, they expand significantly and leave insufficient room for seedlings to germinate or displace seedlings from ideal germination conditions.

### SUMMARY

The present disclosure relates to a system for retaining water and providing nutrients to plantlets. The system is intended to be deployed in areas requiring re-forestation.

It is an object of the system disclosed herein to provide a seedling with access to nutrients and moisture in order to grow and establish in an otherwise harsh environment (e.g. drought, frost, fire ravaged area) that lacks sufficient nutrients and moisture critical for initial seedling establishment.

It is an object of the system disclosed herein to provide a means for re-seeding a deforested area in a more cost effective and less labour intensive way than traditional nursery production.

According to a part of the disclosure, there is a system for retaining water and providing nutrients to plantlets. The system comprises at least two components: (i) an enclosing structure; and (ii) a module disposed in an interior cavity of the enclosing structure. A seed is disposed within the module. Each of the enclosing structure and the module comprises a water controlling agent, an organic material, and a binding material. Each of the enclosing structure and the module may further comprise a seed germination enhancer. Each of the enclosing structure and the module may further comprise a buffering material such as basalt.

The water controlling agent may be a super absorbent polymer. The organic material may be soil, worm casting, or a combination thereof. The seed germination enhancer may be selected from the group consisting of GA3, GA 4+7, and a combination thereof. The seed germination enhancer may be GA3. The seed germination enhancer may be a combination of GA3 and GA 4+7. The binding material may be microcrystalline cellulose.

The ratio of the water controlling agent to the organic material may be between about 1:1 and about 1:6. The ratio of the water controlling agent to the organic material may be between about 1:1 and about 1:3.

The ratio of the organic material to the seed germination enhancer is between about 13000:1 and about 19000:1. The ratio of the organic material to the seed germination enhancer is between about 16000:1 and about 18000:1.

The ratio of water controlling agent to flow agent is between about 20:1 and about 2:1. The ratio of water controlling agent to flow agent is between about 15:1 and about 10:1.

According to another part of the disclosure, there is a system for retaining water and providing nutrients to plantlets. The system comprises at least two components: (i) an enclosing structure; and (ii) a module disposed in an interior cavity of the enclosing structure. A seed is disposed on the module. The enclosing structure comprises one or more organic materials, one or more binding materials, and one or more buffering materials. For example, the enclosing structure may comprise soil, gum, straw, and clay. An example of a gum is xanthan gum. A non-limiting example of a clay is kaolin clay.

The enclosing structure may further comprise a seed germination enhancer. One of the one or more buffering materials may be basalt.

The enclosing structure may further comprise a root growth promoting hormone. Non-limiting examples of suitable hormones include indole-3-acetic acid (IAA) and indole-3-butyric acid (IBA).

The module may be constructed from or substantially from vermiculite.

According to another part of the disclosure, there is a system for retaining water and providing nutrients to plantlets. The system comprises: (a) a first surface that is concaved, an opening, and an exterior wall extending between the first surface and the opening; (b) an interior cavity defined by an interior surface of the exterior wall, a second surface, and an opening that is opposite the second surface; and (c) a channel extending through the first surface and the second surface, the channel comprising a first end and a second end, the channel in fluid communication with the interior cavity, the first end being distal to the interior cavity and the second end being proximal to the interior cavity.

This summary does not necessarily describe the entire scope of all aspects of the disclosure. Other aspects, features and advantages will be apparent to those of ordinary skill in the art upon review of the following description of specific embodiments.

### BRIEF DESCRIPTION OF THE DRAWINGS

In the accompanying drawings, which illustrate one or more embodiments:

FIG. 1(a) is a perspective view of a module for retaining water and providing nutrients to a plantlet according to an embodiment.

FIG. 1(b) is a top view of the module according to FIG. 1(a).

FIG. 1(c) is a side view of the module according to FIG. 1(a).

FIG. 1(d) is a sectioned side view of the module according to FIG. 1(a), as cut along section plane 1-1 of FIG. 1(c).

FIG. 2 is a side view of a module for supporting one or more seeds, according to another embodiment.

FIG. 3(a) is a perspective view of an enclosing structure for retaining water and providing nutrients and protection to a plantlet according to an embodiment.

FIG. 3(b) is a top view of the enclosing structure according to FIG. 3(a).

FIG. 3(c) is a side view of the enclosing structure according to FIG. 3(a).

FIG. 3(d) is a sectioned side view of the enclosing structure according to FIG. 3(a), as cut along section plane 3-3 of FIG. 3(c).

FIG. 3(e) is a bottom view of the enclosing structure according to FIG. 3(a).

FIG. 4 is a sectioned side view of a system according to an embodiment, the system comprising the enclosing structure according to FIG. 3 and the module according to FIG. 1.

FIG. 5 is a sectioned side view of a system according to an embodiment, the system comprising the enclosing structure according to FIG. 3 and the module according to FIG. 2.

FIG. 6 is a sectioned side view of a system according to another embodiment, the system comprising the enclosing structure according to FIG. 3 and a plurality of modules according to FIG. 2.

### DETAILED DESCRIPTION

Directional terms such as “top,” “bottom,” “upwards,” “downwards,” “vertically,” and “laterally” are used in the following description for the purpose of providing relative reference only, and are not intended to suggest any limitations on how any article is to be positioned during use, or to be mounted in an assembly or relative to an environment. The use of the word “a” or “an” when used herein in conjunction with the term “comprising” may mean “one,” but it is also consistent with the meaning of “one or more,” “at least one” and “one or more than one.” Any element expressed in the singular form also encompasses its plural form. Any element expressed in the plural form also encompasses its singular form. The term “plurality” as used herein means more than one; for example, the term “plurality includes two or more, three or more, four or more, or the like.

In this disclosure, the term “about” or “approximately”, when followed by a recited value, means within plus or minus 10% of that recited value.

In this disclosure, the terms “comprising”, “having”, “including”, and “containing”, and grammatical variations thereof, are inclusive or open-ended and do not exclude additional, un-recited elements and/or method steps. The term “consisting essentially of” when used herein in connection with a composition, use or method, denotes that additional elements, method steps or both additional elements and method steps may be present, but that these additions do not materially affect the manner in which the recited composition, method, or use functions. The term “consisting of” when used herein in connection with a composition, use, or method, excludes the presence of additional elements and/or method steps.

In this disclosure, “dry matter”, when referring to organic waste material, means the matter of the organic waste material when water or moisture is removed from the organic waste material.

In this disclosure, the term “fertilizer” refers to synthetic fertilizers (e.g. ammonium nitrate, ammonium phosphate) and organic fertilizers (e.g. compost, manure, worm castings).

In this disclosure, the term “module” refers to a mass comprising one or more materials in any shape or form, whose primary purpose is to provide a seedling disposed therein or thereon access to, or an ability to access, nutrients.

In this disclosure, “organic matter”, when referring to organic waste material, means decomposed materials found in the organic waste material.

In this disclosure, the term “organic waste material” refers to a waste by-product produced by an animal (e.g. an organic fertilizer).

In this disclosure, the term “seed enhancer” means a chemical for improving the likelihood of seed performance consistency.

### System for Retaining Water and Providing Nutrients to Plantlets

The present disclosure relates to a system for retaining water and providing nutrients to plantlets. The system can be adapted for use in improving the planting, germination, and growth of tree seeds and seedlings. The system can be adapted to receive one or more seeds or seedlings therein. The system comprises two components: an enclosing structure and a module. The module is disposed within an internal cavity of the enclosing structure.

In some embodiments, one or both of the module and the enclosing structure disclosed herein can comprise one or more water controlling agents. In some embodiments, one or both of the module and the enclosing structure disclosed herein can further comprise one or more binding materials. In some embodiments, one or both of the module and enclosing structure herein can comprise one or more organic materials. In some embodiments, one or both of the module and the enclosing structure can further comprise a fertilizer. In some embodiments, one or both of the module and the enclosing structure can further comprise one or more dispersants. In some embodiments, one or both of the module and the enclosing structure can further comprise one or more flow control agents. In some embodiments, one or both of the module and the enclosing structure can further comprise one or more fungal materials. In some embodiments, one or both of the module and the enclosing structure can further comprise one or more seed germination enhancers. In some embodiments, one or both of the module and the enclosing structure can further comprise one or more deterrents. In some embodiments, one or both of the module and the enclosing structure can further comprise one or more pH modifiers. In some embodiments, one or both of the module and the enclosing structure can further comprise one or more seed coating resins. In some embodiments, one or both of the module and the enclosing structure can further comprise one or more powders for seed coating. In some embodiments, one or both of the module and the enclosing structure can further comprise basalt. In some embodiments, one or both of the module and the enclosing structure comprises some or all of the foregoing components above.

A water controlling agent can serve, at least in part, to absorb and expand upon contact with water, thereby providing an environment wherein other components (e.g. fertilizers) of the module or enclosing structure can become water soluble and have the potential to be bio-available for seeds to develop into seedlings. Non-limiting examples of a water controlling agent suitable for use in a system for retaining water and providing nutrients to plantlets include acrylate polymers, super absorbent polymers (e.g. SAP, Guangrao Huadongshangcheng), vermiculite, biochar, peat, other suitable water controlling agents, and a combination thereof. An example of another suitable water controlling agent is a potassium-based acrylate polymer. Another example of another suitable water controlling agent is a poly(acrylic acid) partial potassium salt (e.g. CAS: 25608-12-2). The water controlling agent generally comprises about 10% to about 80% of the overall dry weight of the system. For example, the water controlling agent can comprise about 10% to about 70%, about 10% to about 60%, about 10% to about 50%, about 10% to about 40%, about 10% to about 30%, about 20% to about 60%, about 20% to about 50%, about 20% to about 40%, about 20% to about 30%, about 30% to about 60%, about 30% to about 50%, about 30% to about 40%, about 40% to about 60%, about 40% to about 50%, about 50% to about 60% of the overall dry weight of the system. For example, the water controlling agent can comprise about 35% to about 45% of the overall dry weight of the system. The amount of water controlling agent that is used in the system will depend on the climate of the region in which the system is expected to be deployed. For example, if a system containing too much water controlling agent is deployed in very wet conditions, the module itself may erupt.

A binding material can serve, at least in part, to promote adhesiveness between the components of the module and enclosing structure and to allow for compressibility of the module and the enclosing structure. Non-limiting examples of a binding material suitable for use in a system for retaining water and providing nutrients to plantlets include microcrystalline cellulose material, starch, flour, clay, gum, other suitable binding materials, and a combination thereof. Examples of suitable starch include, but are not limited to, native starches, modified starches, polysaccharides, and a combination thereof. Examples of native starches include, but are not limited to, potato starches, corn starches, wheat starches, oat starch, barley starch, rice starches, sorghum starches, and tapioca starches. Examples of modified starches include, but are not limited to, esterified starch, starch phosphate, etherified starches, cross-linked starches, cationized starches, enzymatically digested starches, and oxidized starches. Examples of clay include, but are not limited to, kaolin clay. Examples of gum include, but are not limited to, xanthan gum. The binding material generally comprises about 5% to about 30% of the overall dry weight of the system. For example, the binding material can comprise about 5% to about 25%, about 5% to about 20%, about 5% to about 15%, about 5% to about 10%, about 10% to about 25%, about 10% to about 20%, about 10% to about 15%, about 15% to about 25%, about 15% to about 20%, of the overall dry weight of the system.

A dispersant can serve, at least in part, to facilitate dissolution of a compressed module after said module contacts water. Non-limiting examples of dispersants suitable for use in a system for retaining water and providing nutrients to plantlets include ammonia-free dispersants, formaldehyde-free dispersants, other suitable dispersants, and a combination thereof. In some embodiments, there is no dispersant.

A flow control agent can serve, at least in part, to decrease the likelihood of components of the system adhering to equipment used in the manufacturing thereof. Non-limiting examples of a flow control agent suitable for use in a system for retaining water and providing nutrients to plantlets include stearates (e.g. magnesium stearate), other suitable flow control agents, and a combination thereof. The flow control agent generally comprises about 1% to about 15% of the overall dry weight of the system. For example, the flow control agent can comprise about 1% to about 5%, about 1% to about 10%, about 5% to about 10%, about 3% to about 8%, about 2% to about 7%, about 1% to about 3%, of the overall dry weight of the system.

An organic material can serve, at least in part, to enhance nutrient uptake of certain components of the system, and may further impart one or more tolerances (e.g. drought tolerance, toxin tolerance, etc.,) to one or more components of the system or the system as a whole. Non-limiting examples of an organic material suitable for use in a system for retaining water and providing nutrients to plantlets include soil, castings (e.g. worm castings), plant-growth promoting rhizobacteria, other suitable organic material, and a combination thereof. Examples of suitable castings include those from Red Wrigglers. The organic material generally comprises about 20% to about 70% of the overall dry weight of the system. For example, the organic material can comprise about 20% to about 70%, about 20% to about 60%, about 20% to about 50%, about 20% to about 40%, about 20% to about 35%, about 20% to about 30%, about 20% to about 25%, about 25% to about 35%, about 25% to about 30%, about 30% to about 70%, about 30% to about 60%, about 40% to about 70%, about 40% to about 60%, about 50% to about 70% of the overall dry weight of the system.

A fungal material is, at least in part, intended to enhance a plant root's absorptive area for increasing water and nutrient absorption. Non-limiting examples of fungal materials include mycorrhizal fungi and ectomycorrhiza fungi (e.g. Root Rescue Environmental Products Inc., Waterdown, Ontario, Canada). The fungal material generally comprises about 2% to about 8% of the overall dry weight of the system. In some embodiments, there is no fungal material.

A fertilizer can serve, at least in part, to provide nutrients (e.g. macro-nutrients, micro-nutrients, or both) for supporting seed germination, early seedling development, or both. Non-limiting examples of fertilizers suitable for use in a system for retaining water and providing nutrients to plantlets include ammonium containing fertilizers, urea containing fertilizers, nitrogen containing fertilizers, calcium containing fertilizers, magnesium containing fertilizers, sulfur containing fertilizers, sulfate containing fertilizers, boron containing fertilizers, borate containing fertilizers, copper containing fertilizers, manganese containing fertilizers, zinc containing fertilizers, transition metal containing fertilizers, phosphate containing fertilizers, potassium containing fertilizers, oxide containing fertilizers, potash, and a combination thereof. The fertilizer generally comprises about 2% to about 40% of the overall dry weight of the system. For example, the fertilizer can comprise about 2% to about 35%, about 2% to about 30%, about 2% to about 25%, about 2% to about 20%, about 2% to about 15%, about 2% to about 10%, about 2% to about 5% of the overall dry weight of the system. Fertilizer can be in a granulated formulation. Fertilizer can be in a slow-release formulation. In some embodiments, there is no fertilizer in the system.

A seed germination enhancer can serve, at least in part, to promote the germination of seeds. Non-limiting examples of a seed germination enhancer suitable for use in a system for retaining water and providing nutrients to plantlets include those containing gibberellins, auxins, or both. Other non-limiting examples of a seed germination enhancer suitable for use in a system for retaining water and providing nutrients to plantlets include those containing growth hormones, naphthalene acid, naphthalene acetic acid, salicylic acid, fulvic acid, humic acid, butyric acid, gibberellic acid (e.g. GA-3, GA 4+7), other suitable seed germination enhancers, and a combination thereof. The seed germination enhancer can comprise up to about 0.05% of the overall dry weight of the system. For example, the seed germination enhancer can comprise between about 0.001% to about 0.05%, about 0.001% to about 0.04%, about 0.001% to about 0.03%, about 0.001% to about 0.02%, about 0.001% to about 0.01%, about 0.01% to about 0.05%, about 0.01% to about 0.04%, about 0.01% to about 0.03%, about 0.01% to about 0.02% of the overall dry weight of the system. For example, the seed germination enhancer can comprise about 0.01%, 0.02%, 0.03%, 0.04%, 0.05% of the overall dry weight of the system. In some embodiments, there is no seed germination enhancer in the system.

A deterrent can serve, at least in part, to deter living organisms from consuming the system or any part thereof. Non-limiting examples of a deterrents suitable for use in the system include benzoates, plant derived oils, hot peppers, predator urine, other suitable deterrents, and a combination thereof. Non-limiting examples of benzoates include denatonium benzoate. Non-limiting examples of plant derived oils include peppermint, lavender, eucalyptus, oregano, and extracts thereof. Non-limiting examples of predator urine include coyote urine and mountain lion urine. Where hot peppers are used as a deterrent, such peppers may be fine ground or an extract thereof may be used. In some embodiments, there is no deterrent in the system.

A pH modifier can serve, at least in part, to maintain the pH levels of the system. Non-limiting examples of a pH modifier suitable for use in a system for retaining water and providing nutrients to plantlets include compounds that are able to maintain a pH of a medium at between about 5 and about 6. In some embodiments, there is no pH modifier in the system.

A seed coating resin can serve, at least in part, to provide a protective coating around a seed, to enhance a seed's germination rate, to enhance the viability of an emerging seedling, or any combination thereof. Non-limiting examples of a seed coating resin suitable for use in a system for retaining water and providing nutrients to plantlets include acrylic latex polymers, co-polymer systems such as that taught in U.S. Pub. No. 2006/0240983 to Yamaguchi, compositions comprising an acrylamide monomer, other suitable seed coating resins, and a combination thereof. A non-limiting example of an acrylamide monomer is n-methylol (meth)acrylamide monomer. In some embodiments, there is no seed coating resin in the system.

A powder for seed coating can serve, at least in part, to provide a protective coating around a seed, to enhance a seed's germination rate, to enhance the viability of an emerging seedling, or any combination thereof. Non-limiting examples of powders for seed coatings include carbonate containing compositions, silicate containing compositions (including silica), aluminosilicate containing compositions (e.g. zeolite, bentonite, vermiculite), diatomaceous earth, and a combination thereof. An example of a carbonate containing composition is an alkaline earth metal carbonate (e.g. calcium carbonate). Examples of silicate containing compositions include, but are not limited to, talc and kaolinite. Powders can be dry. Powder seed coatings can be a coating known in the art such as that taught in U.S. Pat. No. 4,250,660 to Kitamura. In some embodiments, there is no powder for seed coating in the system.

A buffering material can serve to provide “buffer” space for the enclosing structure or module. A non-limiting example of a suitable buffering material is basalt. Another non-limiting example of a suitable buffering material is any dry stalk of a cereal plant post grain and chaff removal; an example of such dry stalk is straw. Without a buffering material, it may be difficult for a seedling to emerge from the module or enclosing structure, thereby stifling the growth of the seedling; for example, straw takes up volume in the walls of the enclosing structure or module, thereby reducing the weight of the enclosing structure or module and providing points where organic material (e.g. soil) and binding material can adhere to. In some embodiments, there is no buffering material in the system.

In an embodiment, the enclosing structure comprises soil, gum, straw, and clay. In another embodiment, the enclosing structure comprises soil, xanthan gum, straw, and kaolin clay. In yet another embodiment, the enclosing structure comprises soil, xanthan gum, biochar, and kaolin clay.

Depending on where the system for retaining water and providing nutrients to plantlets may be applied, used, distributed, or deployed, the composition of the system may vary both in terms of the used ingredients and the relative proportions thereof. The system may also have a shape or size that is adapted for a particular application.

### Manufacturing a System for Retaining Water and Providing Nutrients to Plantlets

According to an embodiment of manufacturing a system, organic material is dried in a drying oven (e.g. Isotherm, Fisher Scientific, Pittsburgh, PA, USA) at constant temperature until constant weight. The dried organic material is pulverized using a high speed multi-functional crusher (e.g. BI-DTOOL 2000 gram Electric Grain Grinder). A mixture of whole and pulverized super absorbent polymer (e.g. SAP, Guangrao Huadongshangcheng 23-1, Shandong, China, or a potassium polyacrylate) is added into mixer in a suitable ratio to the organic material. Microcrystalline Cellulose (e.g. Ingredient Depot, North America, Canada) is also added. In some embodiments, ectomycorrhiza is added. In some embodiments, gibberellins (e.g. GA3, GA 4+7, or a combination thereof) is added. In some embodiments, fertilizer (e.g. Lawn fertilizer from Nutrient Ag Solutions comprising a fertilizer composition N 19%, P 12%, Soluble Potash 15% and sulphur 6%) is added. The mixed components may then be formed or compressed and shaped into a desired form (depending on the desired shape of the enclosing structure or the module).

Method of Preparing Seed for Insertion into System

According to an embodiment of preparing seeds for insertion into the system, seeds are obtained from a seed provider (e.g. National Tree Seed Centre of the Canadian Forest Service). Suitable seeds include but are not limited to coniferous seeds such as fir seeds, pine seeds and spruce seeds, angiosperms such as birch, alder and aspen, seeds for agricultural use, and seeds for horticultural use. A non-limiting example of fir seeds is Douglas fir seeds. Non-limiting examples of pine seeds are Jack pine seeds and Lodgepole pine seeds. A non-limiting example of spruce seeds is white spruce seeds.

Seeds can be immersed in a liquid medium for a pre-determined period of time and at a pre-determined temperature. As contemplated herein, the liquid medium is water, the pre-determined period of time is 24 hours, and the pre-determined temperature is room temperature (about 25° C.). In other embodiments, the liquid medium, the pre-determined period of time, and the pre-determined temperature may be selected according to the kind of seed to be planted. The seeds can be then dried and stratified according to a method known in the art. For example, as contemplated herein, the seeds can be dried and stratified at about 5 degrees Celsius for a 28 day period, as discussed in MacDonald, J. E., et al., 2012. Root growth of containerized lodgepole pine seedlings in response to Ascophyllum nodosum extract application during nursery culture. Can. J. Plant Sci. 92: 1207-1212). After drying and stratification, seeds are ready and prepared for use within the system. In other embodiments, the seeds are not stratified.

According to another embodiment, and depending on where and when a system is deployed into the environment, a seed located therein may be coated or may not be coated. Seed coatings generally are present for the purposes of physically protecting the seed from external variables (e.g. environmental variables). A seed coating is often applied when the environment in which the system containing the seed therein is deployed is not expected to experience a moisture event (e.g. a rainfall event) for a prolonged period of time (e.g. over a number of months).

As contemplated in an embodiment of preparing a seed for insertion into a system for retaining water and providing nutrients to plantlets, the seed is initially submerged into a seed germination enhancer. As contemplated in this embodiment, a seed is submerged in a solution of gibberellins (e.g. GA3, GA 4+7). In other embodiments, other suitable seed germination enhancers are used. In other embodiments, the seed is not initially treated with a seed germination enhancer.

After initially treating with a seed germination enhancer, the seed can be coated with a dry powder. The dry powder may be any suitable combination of components. As contemplated in this embodiment, the dry powder is a mixture of diatomaceous earth, calcium carbonate, and talc.

The seed can then be coated with a seed coating resin. Suitable seed coating resins include, but are not limited to, acrylic latex polymers. An example of an acrylic latex polymer is one that comprises n-methylol (meth)acrylamide monomer for improving adhesion of the seed coating resin to the dry powder. Another example of a suitable seed coating resin is “Ridgetex 3311 P” that is manufactured by Ridgemonde Chemicals & Resin SDN.

In other embodiments, a seed may be prepared by other methods known in the art.

### Experimental Results

Table 1 below includes non-limiting examples of systems comprising a plurality of components:

TABLE 1

| | Formula (g) | | | | | | | | | |
|---|---|---|---|---|---|---|---|---|---|---|
| | | | Worm | | | GA4 + | | Talcum | Mg | |
| | Fertilizer | SAP | Casting | GA3 | ECM | 7 | MCC | Powder | Stearate | Colouring |
| Control | 0 | 0 | 0 | 0 | 0 | 0 | 0 | 0 | 0 | 0 |
| Ex. 1 | 10-40 | 100-400 | 350-700 | 0 | 0 | 0 | 50-200 | 25-80 | 20-80 | 1-10 |
| Ex. 2 | 10-40 | 100-400 | 350-700 | 0.01-0.10 | 0 | 0.08-0.35 | 50-200 | 25-80 | 20-80 | 1-10 |
| Ex. 3 | 10-40 | 100-400 | 350-700 | 0.01-0.10 | 40-80 | 0.08-0.35 | 50-200 | 25-80 | 20-80 | 1-10 |
| Ex. 4 | 10-40 | 100-400 | 350-700 | 0 | 40-80 | 0.08-0.35 | 50-200 | 25-80 | 20-80 | 1-10 |
| Ex. 5 | 10-40 | 100-400 | 350-700 | 0.01-0.10 | 40-80 | 0.00 | 50-200 | 25-80 | 20-80 | 1-10 |
| Ex. 6 | 0 | 100-400 | 350-700 | 0.01-0.10 | 0 | 0.08-0.35 | 50-200 | 25-80 | 20-80 | 1-10 |
| Ex. 7 | 0 | 100-400 | 350-700 | 0.01-0.10 | 40-80 | 0.08-0.35 | 50-200 | 25-80 | 20-80 | 1-10 |

For clarity, in Table 1, “GA3” refers to gibberellin A3, “MCC” refers to microcrystalline cellulose, “SAP” refers to super absorbent polymer, “GA4+7” refers to gibberellin A4 and gibberellin A7, and “Mg Stearate” refers to magnesium stearate.

Worm castings is a composition comprising a plurality of components including, but not limited to, dry matter, nitrogen content, phosphorous content, potassium content, organic matter, calcium, and magnesium. In some embodiments, trace elements including, but not limited to, trace elements selected from the group consisting of sodium, aluminum, boron, copper, iron, manganese, zinc, and a combination thereof are also present in the worm castings. The worm castings contemplated herein generally have a dry matter content of between about 30% to about 40%, a total nitrogen content of between about 0.6% to about 1.0%, a total phosphorus content of between about 0.08% and about 0.12%, a total potassium content of between about 0.06% and about 0.08%, and an organic matter content of between about 25% and about 30%. As contemplated in this embodiment, the worm castings have a pH of between about 4.2 and about 4.4 (e.g. 4.21, 4.22, 4.23, 4.24, 4.25, 4.26, 4.27, 4.28, 4.29, 4.30). As contemplated in this embodiment, the carbon to nitrogen ratio in the worm castings is between about 20:1 to about 15:1 (e.g. 15:1, 16:1, 17:1, 18:1, 19:1).

The water controlling agent (e.g. SAP) to organic material (e.g. worm casting) ratio can be between about 1:1 and about 1:7. For example, the water controlling agent (e.g. SAP) to organic material (e.g. worm casting) ratio can be between about 1:1 and about 1:6, about 1:1 and about 1:5, about 1:1 and about 1:4, about 1:1 and about 1:3, about 1:1 and about 1:2. For example, the water controlling agent (e.g. SAP) to organic material (e.g. worm casting) ratio can be about 1:1, about 1:2, about 1:3, about 1:4, about 1.5, about 1:6, about 1:7.

The GA3 to GA 4+7 ratio can be between about 1:35 and about 1:1. For example, the GA3 to GA 4+7 ratio can be between about 1:30 and about 1:1, about 1:25 and about 1:1, about 1:20 and about 1:1, about 1:15 and about 1:1, about 1:10 and about 1:1, about 1:5 and about 1:1. For example, the GA3 to GA 4+7 ratio can be about 1:2, about 1:4, about 1:6, about 1:8, about 1:10.

The organic material (e.g. worm casting) to GA3 ratio can be between about 10000:1 and about 20000:1. For example, the organic material (e.g. worm casting) to GA3 ratio can be between about 13000:1 and about 19000:1, about 14000:1 and about 18000:1, about 15000:1 and about 18000:1, about 16000:1 and about 18000:1, about 16000:1 and about 17000:1. For example, the organic material (e.g. worm casting) to GA3 ratio can be about 15000:1, about 15500:1, about 16000:1, about 16500:1, about 17000:1, about 17500:1.

The water controlling agent (e.g. SAP) to flow control agent (e.g. magnesium stearate) ratio can be between about 20:1 and about 2:1. For example, the water controlling agent (e.g. SAP) to flow control agent (e.g. magnesium stearate) ratio can be between about 20:1 and about 4:1, about 20:1 and about 6:1, about 20:1 and about 8:1, about 20:1 and about 10:1, about 15:1 and about 2:1, about 15:1 and about 4:1, about 15:1 and about 6:1, about 15:1 and about 8:1, about 15:1 and about 10:1. For example, the water controlling agent (e.g. SAP) to flow control agent (e.g. magnesium stearate) ratio can be about 10:1, about 12:1, about 14:1, about 16:1.

The organic material (e.g. worm casting) to flow control agent (e.g. magnesium stearate) ratio can be between about 35:1 and about 18:1. For example, the organic material (e.g. worm casting) to flow control agent (e.g. magnesium stearate) ratio can be between 30:1 and 20:1, 28:1 and 22:1, 26:1 and 24:1, 26:1 and 22:1. For example, the organic material (e.g. worm casting) to flow control agent (e.g. magnesium stearate) ratio can be about 20:1, about 25:1, about 30:1.

In addition to Table 1, Table 2 below includes non-limiting examples of other systems comprising a plurality of components:

TABLE 2

| | Formula (wt %) | | | | | | |
|---|---|---|---|---|---|---|---|
| | SAP | Soil | GA3 | Deterrent | GA4 + 7 | MCC | basalt |
| Ex. 8 | 5-20% | 40-70% | <0.01% | 1-2% | <0.01% | 3-7% | 15-30% |
| Ex. 9 | 6-15% | 50-65% | <0.01% | 1-2% | <0.01% | 4-6% | 20-30% |
| Ex. 10 | 6-15% | 50-60% | <0.01% | 1-2% | <0.01% | 4-6% | 22-27% |

In the embodiments identified in Table 2, soil is used in lieu of worm castings. Without being bound by theory, it is believed that the substitution of worm castings by soil, in at least some instances, decreases the concentration of nutrients available to the seedling, which in turn reduces the likelihood that the seedling will lose moisture content.

In other embodiments, the system comprises: (i) about 45% to about 60% clay and soil; (ii) about 1% to about 5% polymer; and (iii) about 20% to about 30% basalt. In other embodiments, the system further comprises about 5% to about 10% vermiculite. In other embodiments, the system further comprises about 5% to about 25% peat. Table 3 below includes non-limiting examples of other systems comprising a plurality of components:

TABLE 3

| | Formula (wt %) | | | | | | |
|---|---|---|---|---|---|---|---|
| | Clay and | | | | | | |
| | soil | Polymer | mycorrhizae | GA3 | Basalt | Vermiculite | Peat |
| Ex. 11 | about 55% | about 5.0% | 0 | <0.01% | about 25% | about 7.0% | about 7.0% |
| Ex. 12 | about 60% | about 2.5% | 0 | <0.01% | about 25% | about 7.0% | about 7.0% |
| Ex. 13 | about 60% | about 1.1% | 0 | <0.01% | about 25% | about 7.0% | about 7.0% |
| Ex. 14 | about 60% | 0 | 0 | <0.01% | about 25% | about 7.0% | about 7.0% |
| Ex. 15 | about 50% | about 1.0% | 0 | <0.01% | about 22% | about 6.0% | about 22.0% |
| Ex. 16 | about 60% | about 1.2% | <0.1% | <0.01% | about 25% | about 7.0% | about 7.0% |
| Ex. 17 | about 50% | about 1.0% | <0.1% | <0.01% | about 22% | about 6.0% | about 22.0% |

In other embodiments, the system further comprises fertilizers. In other embodiments, the system further comprises a root growth promoting hormone (e.g., indole-3-acetic acid or indole-3-butyric acid).

### An Example of a Module

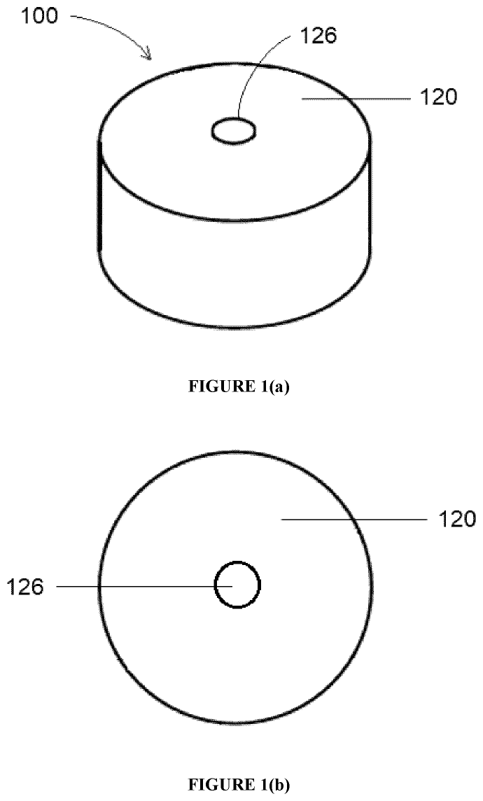

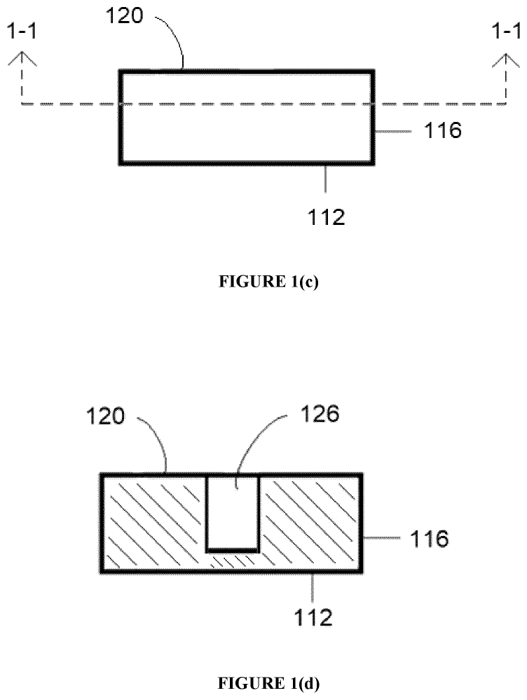

In an embodiment, and as depicted in FIGS. 1(a) to 1(d), there is a module 100 for retaining water and providing nutrients to plantlets. The module 100 is in the shape of a cylinder and comprises a bottom surface 112 and a side-wall surface 116. The module 100 further comprises a receptacle 126 for receiving a seed. In other embodiments, the module may be another suitable shape. For example, the top surface of the module may be concaved so as to better direct the flow of water towards a receptacle of the module.

### Another Example of a Module

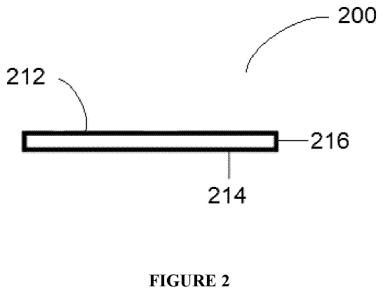

In an embodiment, and as depicted in FIG. 2, there is a module 200 for maintaining a position of a seed relative to an enclosing structure. The module 200 is in the shape of a disk and comprises a first surface 212, a second surface 214, and a side wall 216 extending between first surface 212 and second surface 214. The module 200 is adapted for supporting one or more seeds on the first surface 212, the second surface 214, or both the first surface 212 and the second surface 214. In other embodiments, the module may be any other suitable shape provided that the module comprises a first surface that is adapted to support one or more seeds.

As contemplated in this embodiment, module 200 is constructed from or substantially from vermiculite. Module 200 is prepared by hydraulic press. Module 200 may be pressed at any suitable pressure. For example, module 200 can be pressed at pressures between about 100 PSI and about 1000 PSI, about 200 PSI and about 900 PSI, about 300 PSI and about 800 PSI, about 400 PSI and about 700 PSI, about 500 PSI and about 600 PSI, about 100 PSI and about 400 PSI, about 200 PSI and about 300 PSI. Without being bound to theory, it is believed that a module constructed of or substantially of vermiculite is sufficiently rigid to be handled, but also sufficiently fragile to allow roots of seeds to penetrate it when germination occurs; in addition, hydraulic pressing assisted in retaining water within the module for germination. In other embodiments, the module can be constructed from or substantially from any suitable material.

### An Example of an Enclosing Structure

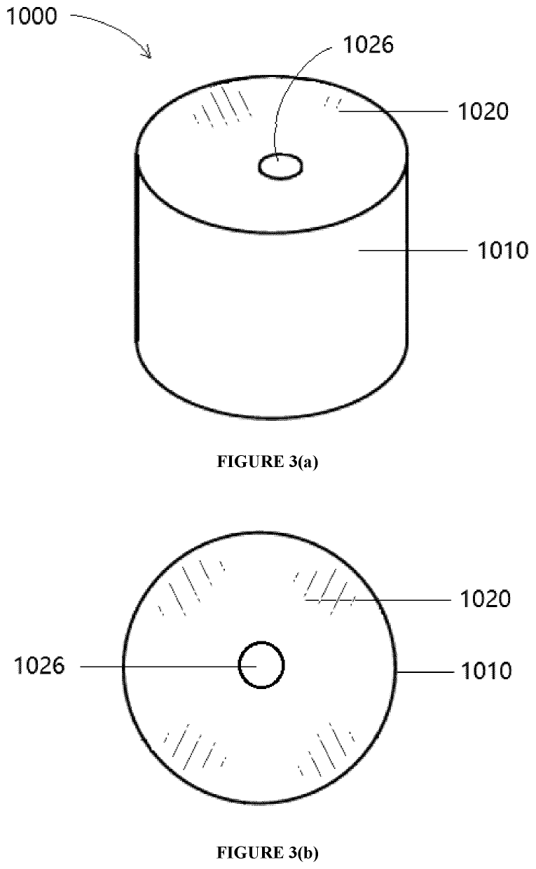

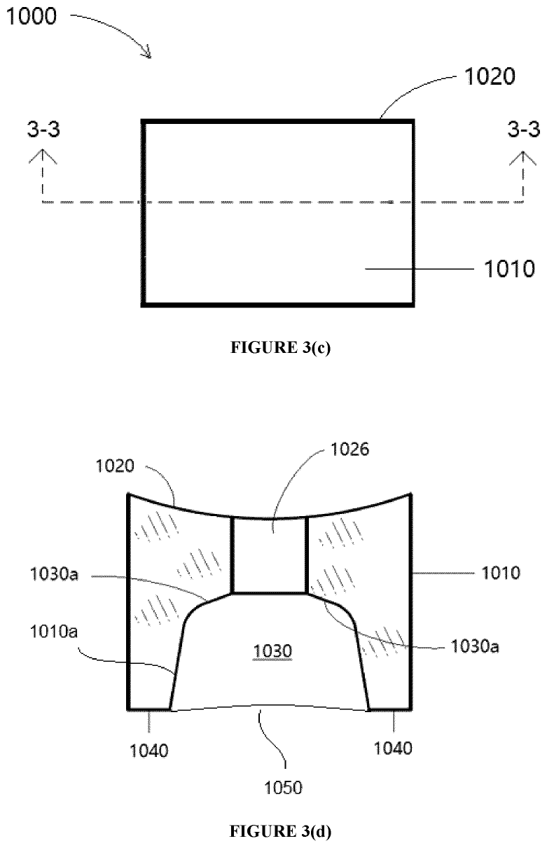

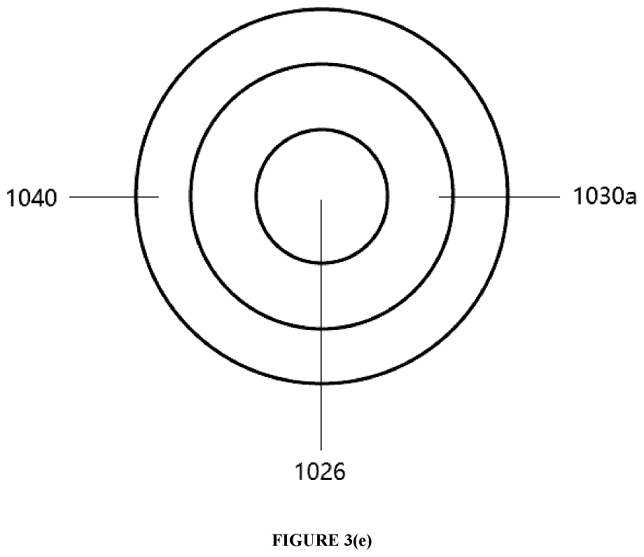

In an embodiment, and as depicted in FIG. 3(a) to 3(e), there is an enclosing structure 1000 for retaining water and providing nutrients to a plantlet and for protecting a module disposed in an interior cavity of the enclosing structure. Enclosing structure 1000 comprises an exterior wall 1010, a first surface 1020, a channel 1026, an interior cavity 1030, and a bottom 1040. First surface 1020 is concaved for the purpose of facilitating the flow of water towards the channel 1026 and into interior cavity 1030. Interior cavity 1030 is delineated by a roof 1030a (also referred to herein as a second surface 1030a), an interior surface 1010a of exterior wall 1010, and an opening 1050 located opposite the second surface 1030a. Opening 1050 is circumscribed by bottom 1040. Through channel 1026, interior cavity 1030 is in fluid communication with an environment exterior to the enclosing structure 1000. As depicted in this embodiment, enclosing structure 1000 is cylindrical in outer appearance. In other embodiments, the enclosing structure can be of any other suitable shape known the art.

In some embodiments, the surfaces of the enclosing structure covered in a hydrophobic substance known the art. Non-limiting examples of suitable hydrophobic substances include a suitable wax. Non-limiting examples of suitable wax include soy wax, beeswax, and paraffin. The hydrophobic substance decreases the likelihood of excess moisture seeping into the enclosing structure and compromising the structural integrity of the enclosing structure while at the same time reduces the loss of moisture from the enclosing structure. In addition, the hydrophobic substance helps redirect water from outside the enclosing structure to where the seeds reside within the inner cavity of the enclosing structure.

In some embodiments, the hydrophobic substance is combined with a second component for the purpose of increasing the melting point of the hydrophobic substance. For example, the second component can be a long-chain fatty acid such as, but not limited to, stearic acid, oleic acid, linoleic acid, and eicosapentaenoic acid. In other embodiments, there is no hydrophobic coating.

### An Example of a System

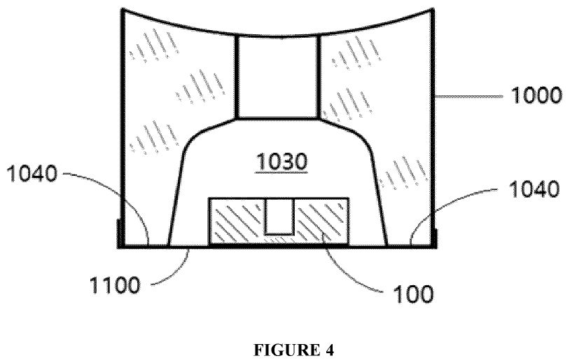

In an embodiment, and as depicted in FIG. 4, there is a system for retaining water and providing nutrients to plantlets. The system comprises an enclosing structure (e.g. enclosing structure 1000), a module (e.g. module 100), and a base 1100 (e.g. a membrane comprising paper and cotton). The module 100 is adhered to the base 1100 using wax. In other embodiments, the module is adhered to the base using another suitable means known in the art. One or more seeds are disposed in receptacle 126 of module 100. Base 1100 is then adhered by wax to base 1040 of enclosing structure 1000, thereby providing an enclosed bottom to interior cavity 1030. In other embodiments, the base is adhered to the base of the enclosing structure using another suitable means known in the art.

In practice, a system containing one or more seeds disposed in the receptacle of the module is deployed in an area requiring reforestation and can be deployed on the surface of the soil or buried in the soil so that the top surface of the enclosing structure is at soil level. The concaved top surface of the enclosing structure directs environmental moisture (e.g. rain) towards the channel of the enclosing structure and into the interior cavity of the enclosing structure. In addition, environmental moisture can also access the interior cavity of the enclosing structure via the base 1100. Environmental moisture entering the interior cavity interacts with the module. The module imbibes environmental moisture and expands, thereby providing the one or more seeds with access to nutrients for germination and subsequent growth. The enclosing structure provides a protective environment in which the one or more seeds may germinate and grow. In some embodiments, wood shavings, sand, or soil is inserted into the channel of the enclosing structure to reduce the direct exposure of the module to the outer environment.

### Another Example of a System

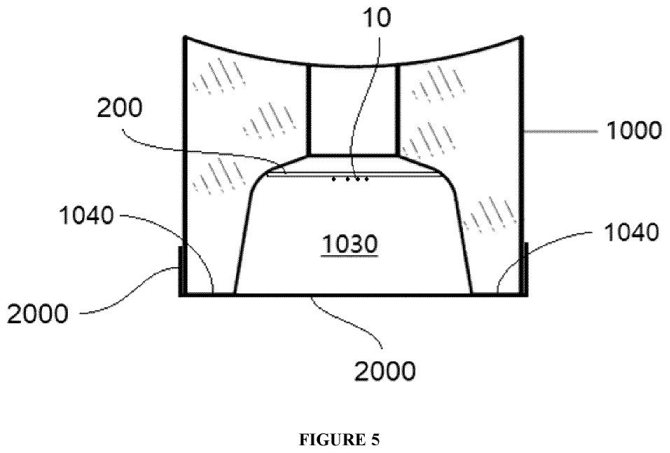

In another embodiment, and as depicted in FIG. 5, there is a system for retaining water and providing nutrients to plantlets. The system comprises an enclosing structure (e.g. enclosing structure 1000), a module (e.g. module 200), and a base 2000. The module 200 is coupled to interior surface 1010a enclosing structure 1000. For example, module 200 can be coupled to enclosing structure 1000 by compression against interior surface 1010a of enclosing structure 1000. For example, module 200 can be coupled to interior surface 1010a of enclosing structure 1000 by the hydrophobic substance. One or more seeds 10 are disposed on the side of module 200 that is distal to the channel 1026 of enclosing structure 1000. The one or more seeds can be coupled to module 200 by wax or other suitable adhesive known in the art. Preferably, the one or more seeds 10 are disposed at a location on module 200 that increases the likelihood of one or more seedlings emerging through channel 1026 of enclosing structure 1000.

Base 2000 comprises paper and cotton. The cotton is prepared into mesh pieces and layered over the paper. Base 2000 is then adhered by wax to base 1040 of enclosing structure 1000 and to the body 1010, thereby providing an enclosed bottom to interior cavity 1030. In other embodiments, the base is adhered to the base and side-wall of the enclosing structure using another suitable means known in the art.

### Another Example of a System

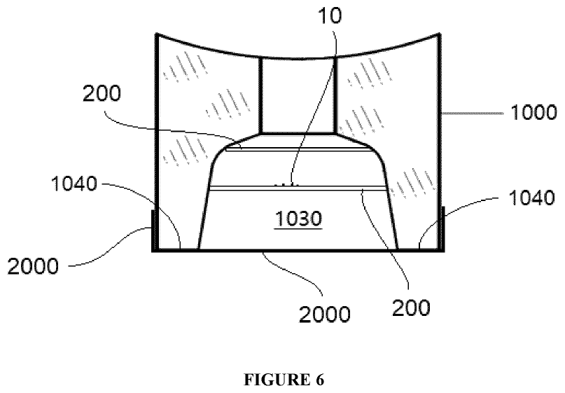

In another embodiment, and as depicted in FIG. 6, there is a system for retaining water and providing nutrients to plantlets. The system comprises an enclosing structure (e.g. enclosing structure 1000), a plurality of modules (e.g. two module 200), and a base 2000. As contemplated in this embodiment, there are two modules 200. A first module 200 is coupled to interior surface 1010a and proximal to second surface 1030a of enclosing structure 1000. A second module 200 is coupled to the interior surface 1010a of exterior wall 1010 and between the first module 200 and a base 2000. One or more seeds 10 are disposed on the side of second module 200 that is proximal to first module 200. The one or more seeds can be coupled to the second module 200 by wax or other suitable adhesive known in the art. Preferably, the one or more seeds 10 are disposed at a location on module 200 that increases the likelihood of one or more seedlings emerging through channel 1026 of enclosing structure 1000.

Base 2000 comprises paper and cotton. The cotton is prepared into mesh pieces and layered over the paper. Base 2000 is then adhered by wax to base 1040 of enclosing structure 1000 and to the body 1010, thereby providing an enclosed bottom to interior cavity 1030. In other embodiments, the base is adhered to the base and side-wall of the enclosing structure using another suitable means known in the art.

### Another Example of a System

In another embodiment, there is a system for retaining water and providing nutrients to plantlets. The system is the enclosing structure (e.g. enclosing structure 1000). One or more seeds are disposed within the interior cavity of the enclosing structure. For example, one or more seeds are placed on or in the ground and the enclosing structure is placed over the one or more seeds, wherein the one or more seeds become disposed within the interior cavity of the enclosing structure.

### General

It is contemplated that any part of any aspect or embodiment discussed in this specification may be implemented or combined with any part of any other aspect or embodiment discussed in this specification. While particular embodiments have been described in the foregoing, it is to be understood that other embodiments are possible and are intended to be included herein. It will be clear to any person skilled in the art that modification of and adjustment to the foregoing embodiments, not shown, is possible.

Unless defined otherwise, all technical and scientific terms used herein have the same meaning as is commonly understood by one of ordinary skill in the art to which this invention belongs. In addition, any citation of references herein is not to be construed nor considered as an admission that such references are prior art to the present invention.

The scope of the claims should not be limited by the example embodiments set forth herein, but should be given the broadest interpretation consistent with the description as a whole.

What is claimed is:

1. A system for retaining water and providing nutrients to plantlets, comprising: (a) a first surface that is concaved, an opening, and an exterior wall extending between the first surface and the opening; (b) an interior cavity defined by an interior surface of the exterior wall, a second surface, and an opening that is opposite the second surface; and (c) a channel extending through the first surface and the second surface, the channel comprising a first end and a second end, the channel in fluid communication with the interior cavity, the first end being distal to the interior cavity and the second end being proximal to the interior cavity.

2. The system as claimed in claim 1, further comprising a first module spatially disposed within the interior cavity between the second end of the channel and the opening, the module adapted to support one or more seeds thereon.

3. The system as claimed in claim 2, further comprising a second module disposed within the interior cavity between the second end of the channel and the first module, wherein a space exists between the first module and the second module.

4. The system as claimed in claim 3, wherein at least one of the first module and the second module is made substantially of vermiculite.

5. The system as claimed in claim 1, further comprising a base for enclosing the opening of the interior cavity that is opposite the second surface.

6. The system as claimed in claim 1, the exterior wall comprising a first organic material, a binding material and a buffering material.

7. The system as claimed in claim 6, wherein the exterior wall further comprises basalt.

8. The system as claimed in claim 6, wherein the exterior wall further comprises a root growth promoting hormone.

9. The system as claimed in claim 6, wherein the combination of the first organic material and the binding material is between about 45% to about 60% of the overall weight of the system.

10. The system as claimed in claim 9, wherein the binding material is clay.

11. The system as claimed in claim 6, wherein the buffering material is a dry stalk of a cereal plant post grain and chaff removal.

12. The system as claimed in claim 6, wherein the exterior wall further comprises a second organic material.

13. The system as claimed in claim 12, wherein the second organic material is peat.

14. The system as claimed in claim 1, the exterior wall comprising a water controlling agent, an organic material, and a binding material.

15. The system as claimed in claim 14, wherein the water controlling agent is selected from the group consisting of an acrylate polymer, a super absorbent polymer, and a combination thereof.

16. The system as claimed in claim 14, wherein the organic material is worm casting, soil, or a combination thereof.

17. The system as claimed in claim 14, the exterior wall further comprising a seed germination enhancer selected from the group consisting of a gibberellin, an auxin, and a combination thereof.

18. The system as claimed in claim 17, wherein the gibberellin is selected from the group consisting of GA3, GA 4+7, and a combination thereof.

19. The system as claimed in claim 14, wherein the binding material is microcrystalline cellulose.

20. The system as claimed in claim 15, wherein the ratio of the water controlling agent to the organic material is between about 1:1 and about 1:3.
